(19) United States
(12) Patent Application Publication
(10) Pub. No.: US 2022/0369550 A1
(43) Pub. Date: Nov. 24, 2022

(54) ELECTRIC TERRAIN WORKING VEHICLE WITH PARKING BRAKE

(71) Applicant: Excel Industries, Inc., Hesston, KS (US)

(72) Inventors: Royce A. Steinert, Hutchinson (US); Brian R. Funk, Hesston (US)

(21) Appl. No.: 17/746,711

(22) Filed: May 17, 2022

Related U.S. Application Data
(60) Provisional application No. 63/189,954, filed on May 18, 2021.

(51) Int. Cl. A01D 34/82; A01D 34/68; A01D 34/64

(52) U.S. Cl. CPC A01D 34/828; A01D 34/6812; A01D 34/64; A01D 2101/00

(57) ABSTRACT

An electric terrain working vehicle having a parking brake actuated in response to an operator presence system detecting the presence of, or the absence of, an operator in relation to the electric terrain working vehicle. The operator presence system may send a signal to a controller and the controller may command the actuation of the parking brake between an engaged stated and a disengaged state.

### CROSS-REFERENCE TO RELATED APPLICATIONS

This application claims the benefit of U.S. Provisional Application 63/189,954, filed May 18, 2021, entitled “Electric Terrain Working Vehicle with Parking Brake.” The entirety of the aforementioned application is incorporated by reference herein.

### FIELD

Aspects provided relate to an electric terrain working vehicle having a parking brake.

### SUMMARY

At a high level, an electric terrain working vehicle may include an operator presence system, a controller, and a parking brake. The operator presence system may be configured to detect the presence of an operator aboard the electric terrain working vehicle and provide a presence indication to the controller. The controller may be configured to cause the parking brake of the electric terrain working vehicle to engage or disengage based upon the presence indication received from the operator presence system. In aspects, the controller may delay causing engagement of the parking brake for a period of time after receiving the presence indication.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a perspective view of an electric terrain working vehicle, in accordance with aspects hereof;

FIG. 2 depicts a top view of the electric terrain working vehicle of FIG. 1, in accordance with aspects hereof;

FIG. 3 depicts a right-side view of the electric terrain working vehicle of FIG. 1 with the right-side rear drive wheel removed, in accordance with aspects hereof;

FIG. 4 depicts a perspective view of a foot well of the electric terrain working vehicle of FIG. 1, in accordance with aspects hereof;

FIG. 5 depicts a rear view of a propulsion system of the electric terrain working vehicle of FIG. 1, in accordance with aspects hereof;

FIG. 6 depicts a right-side view of the propulsion system of the FIG. 5, in accordance with aspects hereof;

FIG. 7 depicts a perspective view of a parking brake, in accordance with aspects hereof;

FIG. 8 depicts a top view of a portion of the parking brake of FIG. 7, in accordance with aspects hereof;

FIG. 9 depicts an exploded view of the parking brake of FIG. 7, in accordance with aspects hereof;

FIG. 10 depicts an exploded view of another parking brake, in accordance with aspects hereof;

FIG. 11 depicts a section view of a rear end of the electric terrain working vehicle of FIG. 1, in accordance with aspects hereof;

FIG. 12A depicts another section view of the rear end of the electric terrain working vehicle of FIG. 1 with an operator platform in a fully lowered position, in accordance with aspects hereof;

FIG. 12B depicts another section view of the rear end of the electric terrain working vehicle of FIG. 1 with the operator platform in a fully raised position, in accordance with aspects hereof;

FIG. 13A depicts another section view of the rear end of the electric terrain working vehicle of FIG. 1 with an operator platform in a fully lowered position, in accordance with aspects hereof;

FIG. 13B depicts another section view of the rear end of the electric terrain working vehicle of FIG. 1 with the operator platform in a fully raised position, in accordance with aspects hereof;

FIG. 14 depicts a perspective view of an alternative operator presence system, in accordance with aspects hereof;

FIG. 15 depicts a perspective view of another alternative operator presence system, in accordance with aspects hereof;

FIG. 16 depicts a perspective view of another alternative operator presence system, in accordance with aspects hereof; and

FIG. 17 depicts a perspective view of another alternative operator presence system, in accordance with aspects hereof.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other present or future technologies. Further, it should be appreciated that the figures do not necessarily represent an all-inclusive representation of the embodiments herein and may have various components hidden to aid in the written description thereof.

At a high level, an electric terrain working vehicle may include an operator presence system, a controller, and a parking brake. The operator presence system may be configured to detect the presence of an operator aboard the electric terrain working vehicle and provide a presence indication to the controller. The controller may be configured to cause the parking brake of the electric terrain working vehicle to engage or disengage based upon the presence indication received from the operator presence system. In aspects, the controller may delay causing engagement of the parking brake for a period of time after receiving the presence indication.

Aspects hereof may be described using directional terminology. For example, the Cartesian coordinate system may be used to describe positions and movement or rotation of the features described herein. Accordingly, some aspects may be described with reference to three orthogonal axes. The axes may be referred to herein as lateral, longitudinal, and vertical, and may be indicated by reference characters X, Y, and Z, respectively, in the accompanying figures. For example, the lateral axis may be associated with a side-to-side direction of a vehicle, the longitudinal axis may be associated with a front-to-back direction of the vehicle, and the vertical axis may be associated with an bottom-to-top direction of the vehicle. Additionally, relative location terminology will be utilized herein. For example, the term “proximate” is intended to mean on, about, near, by, next to, at, and the like. Therefore, when a feature is proximate another feature, it is close in proximity but not necessarily exactly at the described location, in some aspects. Additionally, the term “distal” refers to a portion of a feature herein that is positioned away from a midpoint of the feature.

An electric terrain working vehicle (an “E-vehicle”) comprises various structures and on-board systems mounted to those structures. At a basic level, an E-vehicle will have a frame and wheels coupled to the frame. The frame may comprise stamped sheet metal, tube rails, plates, platforms, rods, tubes, shafts, beams, channels, and other components coupled to one another. These components of the frame may be welded to one another, fastened together with hardware, or otherwise coupled to one another. The wheels carry the frame above a terrain surface. Typically an E-vehicle will have one or more drive wheels and one or more non-drive wheels. For example, an E-vehicle may include a pair or rear drive wheels and one or more front wheels. The pair of rear drive wheels of this example may be operably coupled to a propulsion system of the E-vehicle while the one or more front wheels may not be coupled to the propulsion system. In aspects, the one or more front wheels may not comprise wheels and may instead comprise casters. Some E-vehicles may include independently driven drive wheels, which can provide the E-vehicle with a zero-degree turning radius (“ZTR”).

Some aspects of E-vehicles may comprise walk-behind vehicles in which an operator walks behind the E-vehicle. Walk-behind E-vehicles may include an operator handle coupled to the frame and extending rearwardly and upwardly therefrom. The operator handle may include controls (e.g., propulsion control, implement control, steering control, etc.) and/or systems (e.g., operator presence system, etc.) mounted thereon. The operator may provide propulsion to the E-vehicle with the operator handle (e.g., by pushing, etc.), in accordance with some aspects.

In other aspects, E-vehicles may comprise stand-on vehicles in which an operator stands-on the E-vehicle. Stand-on E-vehicles may include a control tower affixed to the frame and extending upwardly therefrom. The control tower may include controls (e.g., propulsion control, implement control, steering control, etc.) and/or systems (e.g., operator presence system, etc.) mounted thereon. For example, the control tower may include a steering control such as a steering wheel and may also include a propulsion control such as a throttle control. In other aspects, the propulsion and steering of the E-vehicle may be controlled simultaneously. For example, with a pair of steering levers that each independently operate one of a pair of drive wheels, such as in the case of a ZTR vehicle. Typically, a stand-on vehicle includes an operator platform upon which the operator may stand that is positioned rearward of the control tower (e.g., the operator platform may be positioned proximate a rear end of the E-vehicle). The operator platform may comprise a portion of the frame or another structure coupled to the frame, in some aspects. In other aspects, the operator platform may be towed behind the E-vehicle. Some aspects may comprise a convertible stand-on E-vehicle that may convert between a stand-on configuration as described above and a walk-behind configuration as described above except that the control tower pivots rearwardly to function as the operator handle and the operator walks behind the mower instead of standing on the operator platform during operation.

In still other aspects, E-vehicles may comprise riding vehicles in which an operator rides on the E-vehicle. Riding E-vehicles may include an operator seat coupled to the frame. In aspects, the operator seat is positioned at an intermediate point along the longitudinal axis of the vehicle. In other aspects, the operator seat may be positioned proximate a rear end of the E-vehicle. The operator seat may include controls (e.g., propulsion control, implement control, steering control, etc.) and/or systems (e.g., operator presence system, etc.) positioned proximate thereto. For example, steering levers or a steering wheel may be positioned within reach of the operator seated in the operator seat. Some controls (e.g., a brake, a height adjustment assembly, etc.) may be operated by a foot-pedal positioned within reach of the operator seated in the operator seat. Other controls (e.g., a power on/off, a power take-off switch, headlight switch, etc.) may be mounted to the frame and positioned within reach of the operator seated in the operator seat.

E-vehicles also include a power supply. The power supply may comprise one or more batteries. In some aspects, the one or more batteries may comprise lead-acid batteries. In other aspects, the one or more batteries may comprise lithium-ion batteries. Other types of batteries now known or later developed may also be used without departing from the scope of the invention described herein. The power supply may be coupled to any portion of the frame. In stand-on E-vehicles, the power supply may be mounted on the frame forward of the control tower. In riding E-vehicles, the power supply may be mounted on the frame rearward of, or underneath, the operator seat. The power supply may be configured to provide power to various systems (e.g., a propulsion system, a steering control system, etc.) and features (e.g., headlamps, an implement, etc.) of the E-vehicle.

E-vehicles also include one or more terrain working implements. An implement may be powered (e.g., a cutting deck and cutting blades of a mower, a blower, etc.) or non-powered (e.g., a blade, a broom, etc.). The implement may be coupled to the frame. In aspects, the implement may be removably coupled to the frame. In further aspects, the implement may be adjustable relative to the frame such that the implement may move between different positions relative to the frame. Powered implements may be driven by a prime mover mounted to the frame of the E-vehicle or by a prime mover mounted to the implement itself. In aspects, the powered implements receive power from the power supply. For example, one or more motors may be coupled to the implement to drive the implement and may receive power from the power supply.

A propulsion system may be configured to provide propulsion to the E-vehicle. For example, a walk-behind vehicle may be self-propelled and stand-on and riding vehicles may be driven. In aspects, the propulsion system of the E-vehicle may comprise a motor coupled to a drive wheel. The motor may be directly coupled to the drive wheel or may be indirectly coupled to the drive wheel (e.g., via one or more gears, via a transaxle, etc.). In some aspects, the E-vehicle includes more than one motor. For example, in a ZTR E-vehicle, there may be two motors coupled independently to two drive wheels. In still other aspects, the E-Vehicle may have motors coupled to more than two wheels or to all of the wheels. In these aspects the motors may work independently or in conjunction to drive the vehicle. The motor is, or the motors are, operatively coupled with the power supply. Propulsion of the E-vehicle may thus be controlled by selectively supplying power to the motor, or motors. Further, each motor may comprise a direct current motor such that inverting the supply of power changes the direction of propulsion (e.g., forward or rearward propulsion).

The amount of power supplied to the motor, and thus the amount of propulsion generated, may be controlled by a propulsion control positioned within reach of an operator of the E-vehicle (e.g., on the operator handle, on the control tower, proximate the operator seat and within arms or foots reach, etc.). In aspects, the propulsion may be statically set such that a speed is selected by the operator and the E-vehicle is provided the associated amount of power to maintain the selected speed. In other aspects, the propulsion may be dynamically controlled such that speed may vary during operation of the E-vehicle as adjusted by the operator. Dynamic control of propulsion may be achieved with propulsion input devices that move relative to a portion of the E-vehicle (e.g., the frame, the operator handle, the control tower, etc.). Examples of propulsion input devices include throttle controls (e.g., such as those typically associated with motorcycles), joysticks, pivot rods, steering levers, etc. Movement of the propulsion input device causes power to be supplied to the motor and propulsion of the E-vehicle. This movement may be measured by a sensor and a signal may be communicated to a control system that instructs the associated supply of power be provided to the motor, in accordance with some aspects. In other aspects, the movement may directly or indirectly operate a switch connected to a circuit that supplies power to the motor.

In some aspects, a steering control may be independent of the propulsion control. For example, the E-vehicle may include a steering wheel or other steering input that controls the direction the vehicle moves when propulsion is supplied. In such aspects, the steering control may be mechanically coupled to one or more wheels, which turn in response to adjustment of the steering control. In other aspects, the steering control may be electrically coupled to an actuator that turns a wheel in response to adjustment of the steering control. Further aspects may include additional actuators that turn additional wheels. The actuators may comprise electric actuators operatively coupled to the power supply, hydraulic actuators, or other types of actuators. As with the propulsion system, movement of the steering input may be measured by a sensor and a signal may be communicated to a control system that instructs the associated movement of the wheel. Similarly, movement of the steering input may directly or indirectly operate a switch connected to a circuit that supplies power to the actuators. As discussed above, the propulsion control and the steering control may be integrated in some aspects. For example, ZTR E-vehicles may independently control drive wheels such that drive wheels turning at different speeds will change the direction of the propelled vehicle.

Some aspects of E-vehicles may include a control system for controlling various systems and features. The control system may receive signals from sensors distributed about the E-vehicle and instruct various commands in response to the received signals, in some aspects. Alternatively, or additionally, the control system may monitor electric circuits for a change in voltage and/or current and instruct various commands in response to monitored changes in voltage and/or current, in other aspects. The control system may comprise a central control system receiving signals and/or monitoring inputs from distributed sensors and systems. The control system may alternatively comprise a distributed control system where various controllers are associated with individual sensors and system for controlling only a single or a few systems or features of the E-vehicle. For example, each motor may have an independent controller dedicated to receiving signals from sensors associated with a steering input and a propulsion input associated with such motor and dedicated to controlling power supplied to such motor in response to the received signals.

In some aspects, the motor may not apply a braking force to the E-vehicle when propulsion is not being provided. Thus, in these aspects the E-vehicle may move when stopped on a hill or slope or when an external force is applied to the E-vehicle (e.g., when pushed). Sometimes it may not be desirable for the E-vehicle to move when propulsion is not provided. Thus, a parking brake may be coupled to, or integrated with, the E-vehicle. The parking brake may be mechanically set or electrically set. For example, a foot pedal or lever, or a hand lever, may actuate the parking brake via a linkage and/or a push-pull cable, a cam, or some other mechanical coupling. By way of another example, an actuator may actuate the parking brake in response to instructions from the control system and/or an electric signal received or monitored.

Some parking brakes may inhibit rotation, resist rotation, and/or prevent rotation of an output shaft of the motor, a gear, a transaxle, an intermediate shaft, or the drive shaft. A frictional force may be applied by pressing a first portion of the parking brake that does not rotate (e.g., a caliper, a brake pad, a brake shoe, etc.) against a second portion of the parking brake that does rotate (e.g., a brake rotor, a brake drum, etc.).

Operator presence systems (“OPS”) may be included in E-vehicles to detect the presence of the operator. OPS generally include a member configured to move in response to the presence of an operator. In response to movement of the member a sensor configured to detect such movement sends a signal to the control system, in some aspects. In other aspects, movement of the member directly or indirectly actuates a switch connected to an electric circuit. In these aspects, the control system may monitor a voltage and/or a current of the electric circuit. In response to the received signal from the sensor or from a change in monitored voltage and/or current, the control system may instruct various systems to initiate action, continue action, discontinue action, engage, disengage, actuate, etc. For example, when the control system determines presence of the operator, it may then instruct a parking brake to disengage. Likewise, when the control system determines absence of the operator, it may then instruct the parking brake to engage. The control system may also control other systems and features of the E-vehicle based on a sensed or monitored OPS. For example, the implement, propulsion, steering and other systems may be controlled in this way.

In the figures that follow, the E-vehicle will be described in reference to a particular embodiment of a zero-turn stand-on mower. However, the illustrated embodiment is merely one aspect of the present invention, which may be employed on numerous other types of mowers (e.g., a riding mower, a walk-behind mower, a non-zero turn mower, etc.).

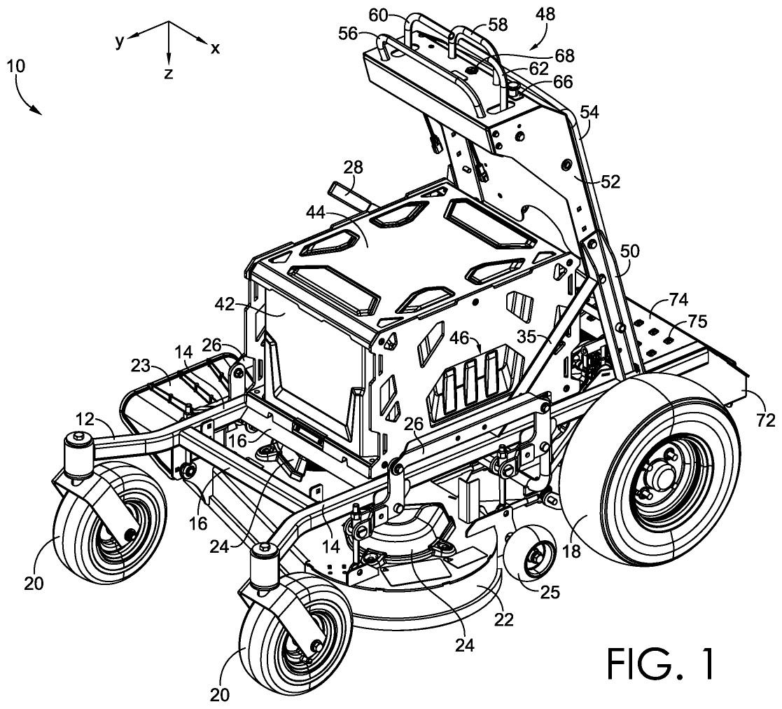

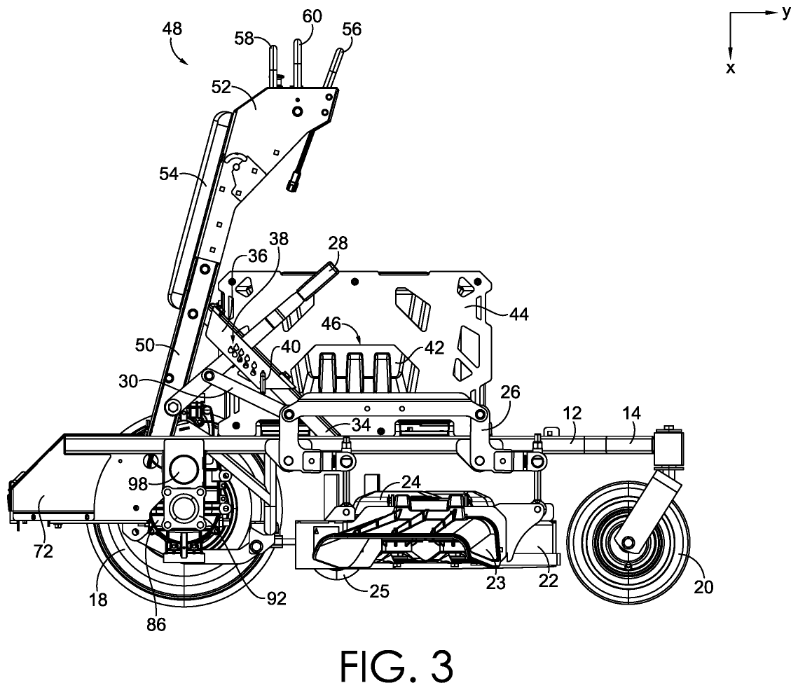

Turning now to the figures generally, and in particular to FIGS. 1-3, a zero-turn, stand-on, electric-powered mower 10 is depicted. The mower 10 includes a frame 12. The frame 12 generally includes a pair of frame rails 14 spaced apart in the lateral direction and extending in the longitudinal direction of the mower 10. The frame rails 14 are connected by cross-members 16. The cross-members 16 may comprise cross-beams, cross-tubes, plates, rods, shafts, or other structures that extend from one frame rail 14 to the other frame rail 14. The cross-members 16 may be welded, fastened or otherwise rigidly attached to the frame rails 14. In other aspects, the cross-members 16 may be integral to the frame rails 14.

The frame 12 is carried over a terrain surface by a pair of drive wheels 18 and a pair of front wheels 20. The pair of drive wheels 18 are each independently driven by a propulsion system. The pair of front wheels 20 are not driven by the propulsion system.

Coupled to the frame 12 is a cutting deck 22. The illustrated cutting deck 22 includes two blades (not shown), each independently driven by a deck motor 24. Other aspects may include more or fewer blades. Coupled to the cutting deck 22 is a discharge chute 23. The discharge chute 23 is configured for side discharge of clippings. In other aspects, the discharge chute may comprise a rear discharge chute that is configured for rear discharge of clippings (e.g., rearwardly between the wheels, rearwardly outside one or both of the wheels, etc.). The cutting deck 22 may also include one or more anti-scalp wheels 25, which may be configured to provide an even cut on an uneven terrain surface.

The cutting deck 22 is coupled to the frame 12 by a height adjustment linkage 26. The height adjustment linkage 26 is configured to raise and lower the cutting deck 22 relative to the frame 12 in the vertical direction. In this way, the mower 10 may cut grass at selectable heights above the terrain surface. The height adjustment linkage 26 may be actuated with a hand lever 28 coupled to a connecting link 30 of the height adjustment linkage 26. When the hand lever 28 is pivoted (e.g., about an axis extending in the lateral direction), the connecting link 30 mechanically moves the height adjustment linkage 26, which results in the cutting deck 22 moving in the vertical direction. The height adjustment linkage 26 may be held in a desired position with a height lock 32. The height lock 32 illustrated comprises a strut 34 coupled to the frame 12 and a plate 36 coupled to the strut 34. The strut 34 and the plate 36 each include a plurality of reciprocal holes 38 aligned with one another in the lateral direction. Each pair of the plurality of reciprocal holes 38 is positioned along the strut 34 and the plate 36 at positions corresponding to a height of the cutting deck 22 above a terrain surface. A locking pin 40 is sized to extend through the plurality of reciprocal holes 38 and hold the hand lever 28, and therefore the height adjustment linkage 26 and cutting deck 22, at the desired position.

The mower 10 also includes a power supply. The power supply includes one or more batteries 42 enclosed in a cage 44. The cage 44 may comprise one or more plates, rods, bars, sheets, and the like that are coupled to the frame 12 and configured to hold the one or more batteries 42. The cage 44 may include one or more openings 46, which may provide cooling to the one or more batteries 42. In addition, portions of the cage 44 may be removable such that access to the one or more batteries 42 is provided and/or the one or more batteries 42 may be removed from the cage 44. The one or more batteries 42 comprise rechargeable lead-acid batteries. In other aspects, the one or more batteries 42 comprise lithium-ion batteries. The power supply is generally positioned towards a central location of the mower 10 in the longitudinal direction. In other aspects, the power supply may be coupled to any portion of the mower 10.

Rearward of the power supply is a control tower 48. The control tower 48 is coupled to the frame 12 and extends vertically therefrom. The control tower 48 illustrated in FIGS. 1-3 comprises a pair of opposing legs 50 each coupled to the frame 12 at the frame rails 14. A plate assembly 52 is coupled to the top portion of the opposing legs 50. The plate assembly 52 may comprise one or more plates coupled together (e.g., welded, fastened, etc.). In some aspects, one or more plates of the plate assembly 52 may comprise stamped sheet metal. An operator pad 54 is coupled on the rearward facing surface of the plate assembly 52, against which an operator may lean during operation of the mower 10. The pair of opposing legs 50 may be braced by the strut 34 and a second strut 35. Thus, the strut 34 and the second strut 35 may extend from the frame 12 to the control tower 48.

A forward grab bar 56 and a rearward grab bar 58 may be fixed to the top of the control tower 48. In aspects, an operator may grasp either, or both, of the forward grab bar 56 or the rearward grab bar 58 during operation of the mower 10. Also mounted to the top of the control tower 48 are a first steering lever 60 and a second steering lever 62. The first steering lever 60 and the second steering lever 62 are each independently, pivotally mounted to the control tower 48. The first steering lever 60 may be configured to control the operation of a right drive wheel 18 and the second steering lever 62 may be configured to control the operation of a left drive wheel 18. For example, the first steering lever 60 may pivot forwardly to initiate forward propulsion of the right drive wheel and may pivot rearwardly to initiate rearward propulsion of the right drive wheel. The second steering lever 62 may operate in the same manner with regard to the left drive wheel 18. In other aspects, one, or both, of the forward grab bar 56 and the rearward grab bar 58 may be pivotally mounted to the control tower 48 for rotation about a laterally extending axis. In these aspects, the grab bars 56 and 58 may rotate forward and/or rearward to limit the travel of the first and second steering levers 60 and 62, which in turn may limit the amount of propulsion provided by the drive wheels 18, which may be advantageous on sloping terrain, or for operator training, among other purposes.

One or more additional controls may also be coupled to the control tower 48. For example, a power takeoff switch 66 may be coupled to the control tower 48 configured for controlling a supply of power to the deck motors 24. A keyed switch 68 may also be coupled to the control tower 48 and configured for energizing the mower 10 when a key is received and engaged therein.

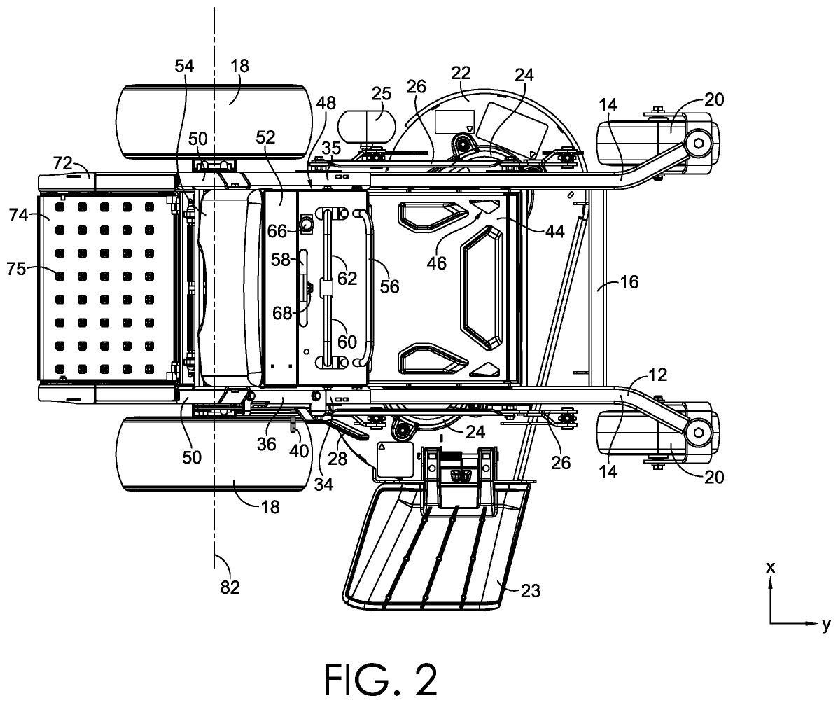

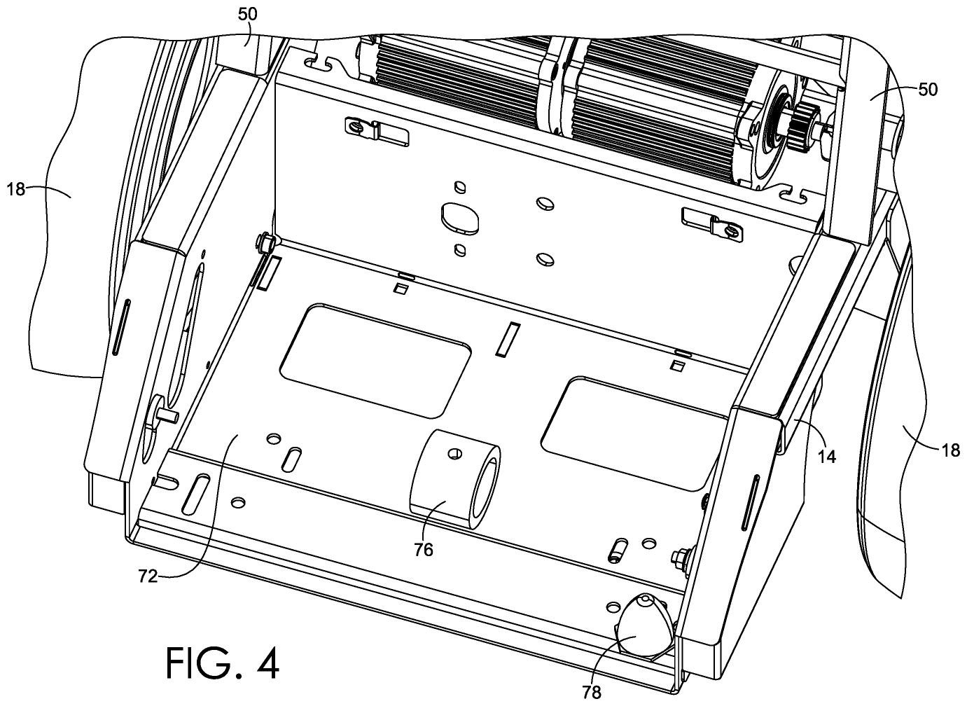

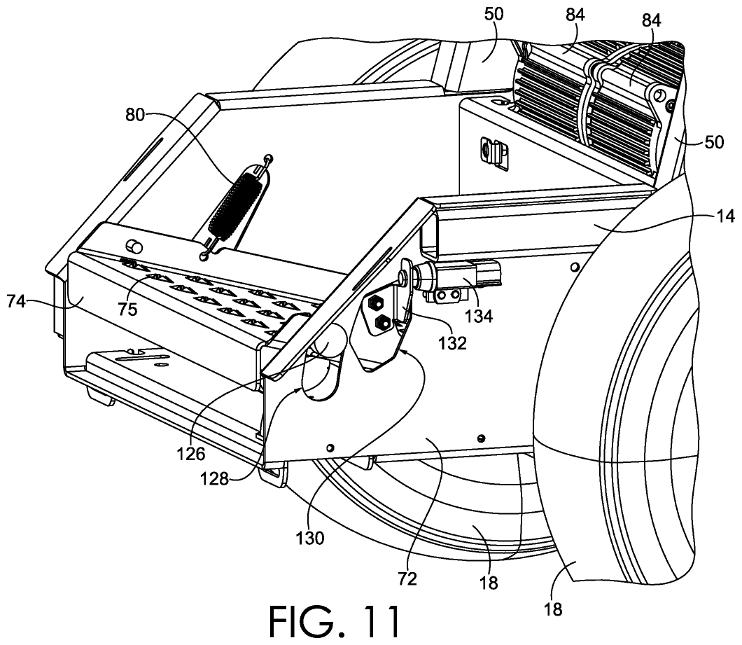

Referring to FIG. 4, coupled to a rear portion of the frame 12 is a foot well 72. The foot well 72 may comprise stamped sheet metal coupled between each of frame rails 14. The foot well 72 may be configured to receive an operator platform 74 (shown in FIG. 2). As discussed in more detail below, the operator platform 74 may be pivotally mounted in the foot well 72. In aspects, the operator platform 74 is stamped sheet metal. The operator platform 74 may include surface features 75 to improve traction for an operator. One or more dampers may resist movement of the operator platform 74. For example, a primary compression damper 76 may be centrally located in the foot well 72 to resist downward movement of the operator platform 74. A secondary compression damper 78 may be rearwardly located in the foot well 72 to further resist downward movement of the operator platform 74. The rearward location may provide a delayed resistance when the operator platform 74 is pivotally coupled at a forward portion because the rearward edge of the operator platform 74 must travel farther. In addition, a tension damper 80 may be coupled to the foot well 72 and the operator platform 74. In the illustrated aspect, the tension damper 80 (shown in FIG. 11) and the secondary compression damper 78 are positioned on opposite sides of the foot well 72 to resist rotation of the operator platform 74.

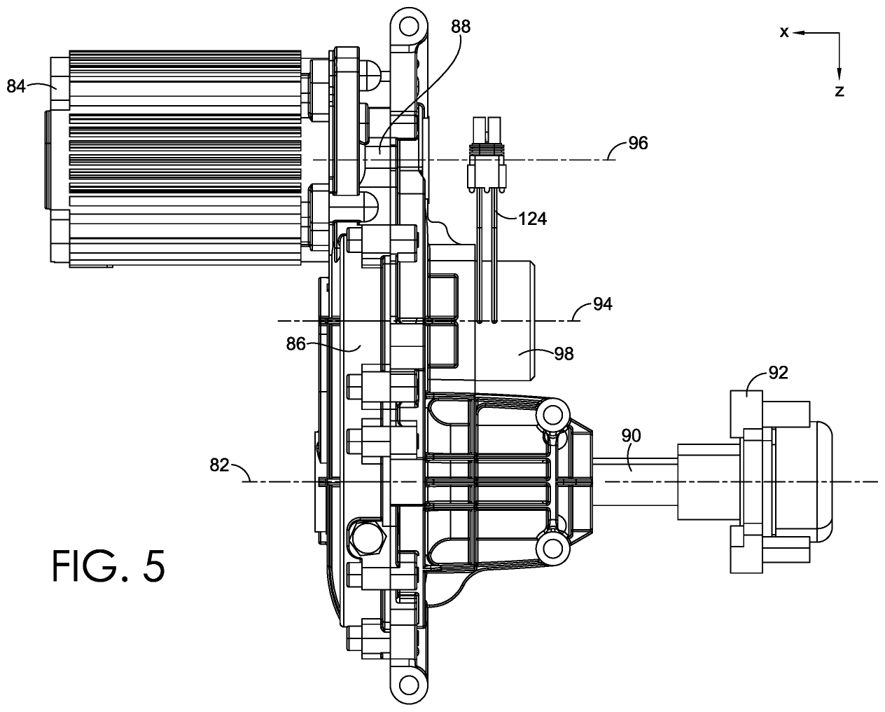

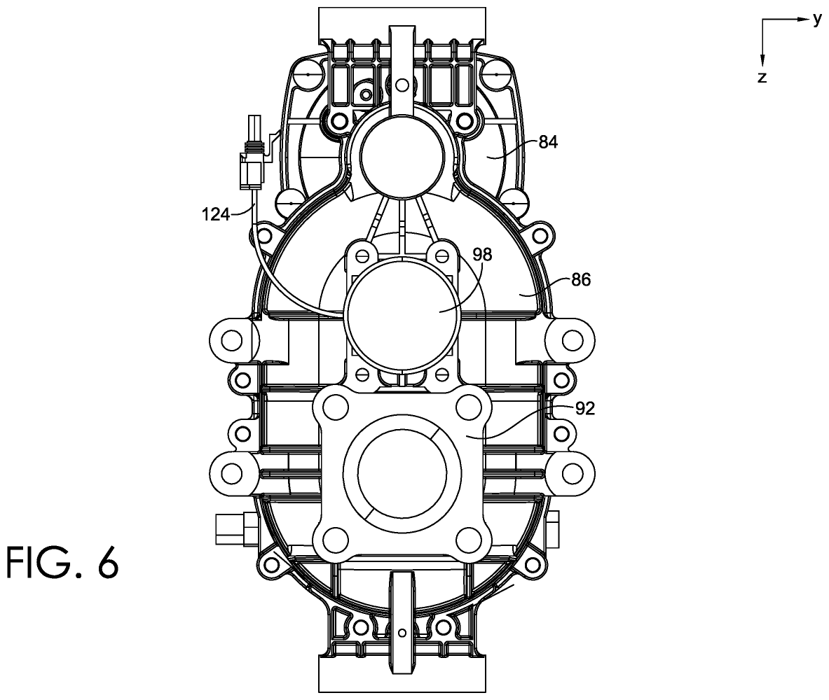

The propulsion system of the mower 10 is positioned forward of the foot well 72, as partially seen in FIG. 2. The drive wheels 18 rotate about a lateral extending axis 82. Powering each of the drive wheels 18 is an electric motor 84 and transmission 86, best seen in FIGS. 5 and 6. The electric motor 84 is electrically coupled to the power supply described above. When power is supplied, the electric motor 84 outputs a torque to a shaft 88. Shaft 88 rotates around lateral extending axis 96. Shaft 88 is mechanically coupled to an intermediate gear shaft (not shown) housed in transmission 86. The intermediate drive shaft rotates around lateral extending axis 94. The intermediate gear shaft is also mechanically coupled to a drive gear shaft 90 that is partially housed in transmission 86 and partially ends laterally out of the transmission 86 to a hub 92. The drive wheel 18 is mounted to hub 92, but is not illustrated in FIGS. 5 and 6 for clarity.

As seen in FIGS. 5 and 6, the electric motor 84 and the transmission 86 are vertically oriented. As compared with prior art mowers, where the motor and transmission were horizontally oriented, the orientation of the present mower provides several advantages. For example, the vertical alignment allows for a narrower distance between frame rails 14 in the lateral direction, which can save costs and material and can allow for a narrower mower. Similarly, the vertical alignment allows for shorter frame rails 14 in the longitudinal direction because the transmissions do not extend rearwardly, which can again save costs and material and can allow for a longitudinally shorter mower. In addition, the vertical alignment also can provide for a laterally wider foot well 72 because the side walls of the foot well 72 need not be offset inwards from the frame rails 14 to allow space for the transmission as was necessary in the prior art.

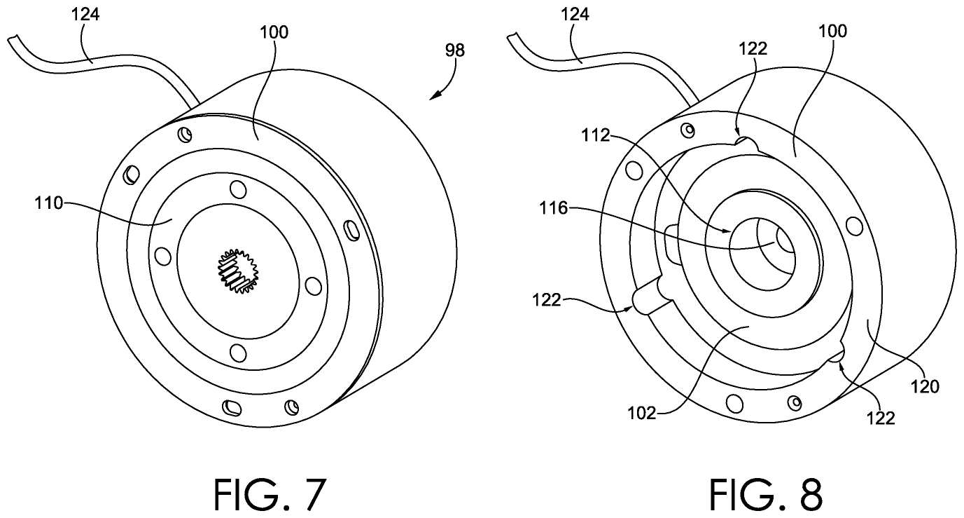

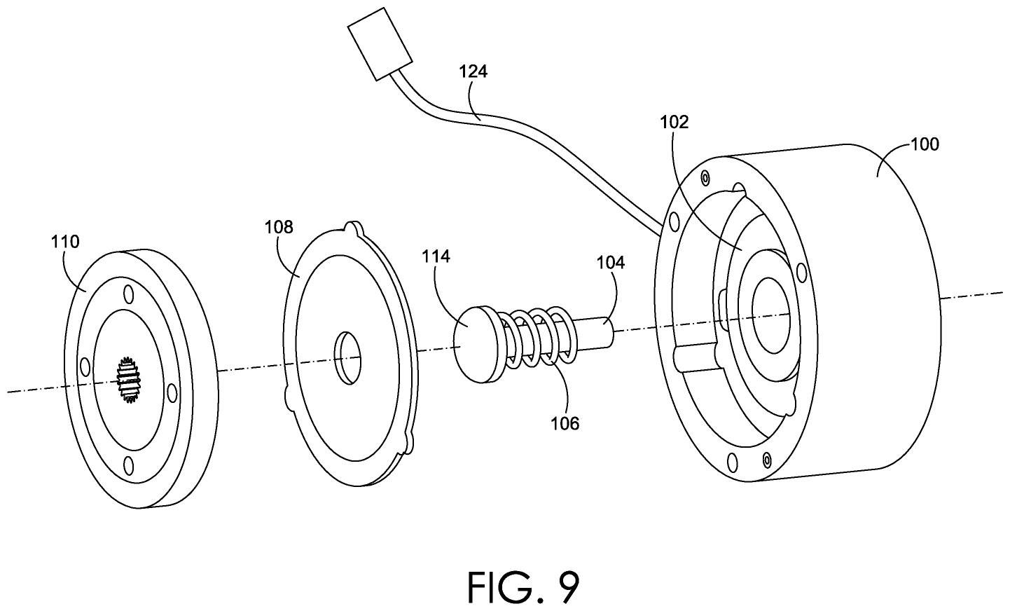

Coupled to the transmission 86 is a parking brake 98. The parking brake 98 may be electrically coupled to the power supply described above. As shown in FIG. 6, the parking brake 98 is attached to the transmission 86 and aligned with the intermediate gear shaft and lateral extending axis 94. Referring to FIGS. 7-9, one aspect of the parking brake 98 is described. The parking brake 98 of this aspect is electrically released and mechanically set. The parking brake 98 includes a housing 100 enclosing a winding 102, a pin 104, a spring 106, a brake pad 108, and a rotor 110. Each of these components is enclosed within the housing 100 when the parking brake is coupled to the mower 10.

The housing 100 includes a central slot 112 that is configured to receive the pin 104 and the spring 106 and a radially outer slot 118 that is configured to receive the winding 102. The pin 104 includes a head 114 and the spring 106 is coiled around the pin 104 between the head 114 and an outer wall 116. An outer radial wall 120 has grooves 122 formed therein for receiving portions of the brake pad 108. When assembled, the winding 102, the pin 104, and the spring 106 are positioned between the brake pad 108 and the outer wall 116. On the opposite side of the brake pad 108 is the rotor 110. The rotor 110 is mechanically attached to the intermediate gear shaft and rotates around lateral extending axis 94 when the associated drive wheel is propelled. Electricity is supplied to the winding 102 by an input cable 124, which is electrically coupled to the power supply.

The parking brake 98 is set when power is not supplied to the winding 102 and the spring 106 presses the head 114 of the pin 104 into the brake pad 108, which in turn presses against the rotor 110. Pressing against the rotor 110 creates a frictional force that halts rotation of the intermediate gear shaft. The parking brake 98 is released when power is supplied to the winding 102, which generates an electro-magnetic field that drives the pin 104 laterally outward to compress the spring 106 and release the pressure applied by the brake pad 108 to the rotor 110. Releasing this pressure allows the intermediate gear shaft to rotate free of the parking brake 98. Thus, supplying power or ceasing the supply of power to the parking brake 98 results in disengaging or engaging the parking brake 98. Control of the power supplied to the parking brake 98 may be accomplished with a switch in the electric circuit supplying power to the parking brake, in some aspects. In other aspects, a controller, positioned at the parking brake 98, at a central hub, or at another location on the mower 10 may control the supply of power to the parking brake 98.

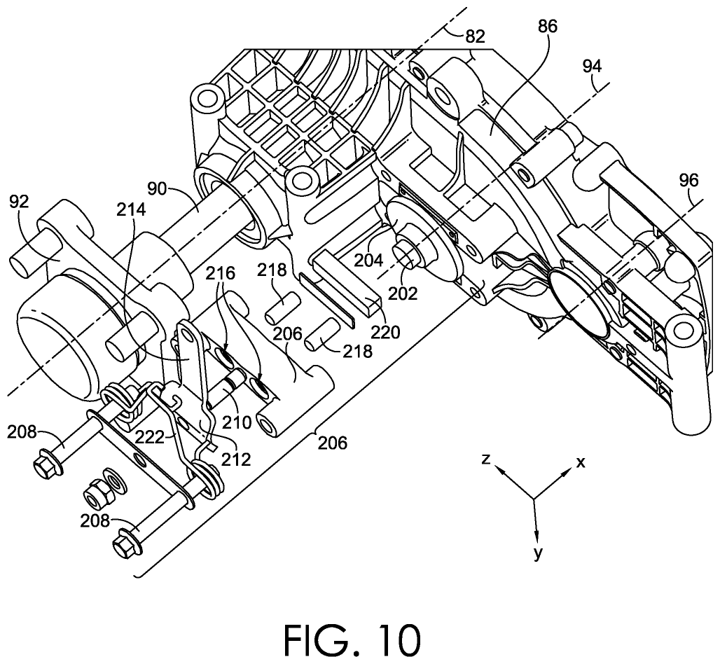

An alternative aspect of a parking brake 200 is depicted in FIG. 10, where like features are labeled with like reference numbers. The parking brake 200 is also coupled to the transmission 86 and aligned with an intermediate gear shaft 202. A rotor 204 is mounted to the intermediate gear shaft 202. A brake mount 206 is fastened to the transmission 86 through fasteners 208. The brake mount 206 includes a pivot rod 210 extending laterally outwardly therefrom. A cam 212 is pivotally coupled to the pivot rod 210. The cam 212 includes a shaft 214 extending longitudinally therefrom. A pair of passageways 216 are formed through the brake mount 206 and positioned on opposite sides of the pivot rod 210. A pin 218 is received in each of the passageways 216. A brake pad 220 is affixed to the ends of each pin 218.

The parking brake 200 is set when the cam 212 is rotated around the pivot rod 210, which causes the cam 212 to engage the pins 218 and thereby press the brake pad 220 against the rotor 204. Pressing the rotor 204 creates a frictional force that halts rotation of the intermediate gear shaft 202. The parking brake 200 is released when the cam 212 is not rotated around the pivot rod 210 (i.e., in a neutral position) such that the cam 212 does not engage the pins 218, which releases the pressure applied by the brake pad 220 to the rotor 204. The parking brake 200 further includes a spring 222 which biases the shaft 214 and the cam 212 to the neutral position. The parking brake 200 may be controlled by moving the shaft 214. In some aspects, the shaft 214 may be mechanically controlled via a linkage or push-pull cable coupled to the shaft 214. In these aspects, a lever, a foot pedal, or another input device may actuate the shaft 214 to set or release the parking brake 200. In other aspects, an actuator may move the shaft 214. The actuator may be electrically controlled (e.g., by a controller).

Although the parking brakes 98 and 200 are depicted in alignment with, and provide braking through, the intermediate gear shaft, alternative aspects are in alignment with, and provide braking through, other portions of the propulsion system. For example, the parking brakes 98 or 200 could apply braking through the drive shaft 90 that rotates about lateral extending axis 82. Or, the parking brakes 98 or 200 could apply braking through the output shaft 88 of the motor 84. Similarly, although the parking brakes 98 and 200 are depicted as coupled to an outboard side of the transmission 86, they need not be. For example, the parking brakes 98 or 200 could be coupled on an inboard side of the transmission 86 or to an inboard side of the motor 84.

As discussed above, setting of the parking brake 98 or 200 may be controlled electrically. For example, a switch in an electric circuit may be opened or closed in response to an action (e.g., an operator being present or not being present on the mower 10) and the open or closing of the switch may set or release the parking brake 98 or 200. Or, a controller (e.g., located at the parking brake, at a central hub, or at another location on the mower 10) may monitor a signal, a voltage, or a current and upon an indication in the signal or a change in the voltage or current may instruct actuation (e.g., setting or releasing of the parking brake 98 or 200). In aspects, the signal monitored by the controller may be from a sensor (e.g., and operator presence sensor).

The mower 10 includes an operator presence system. Depicted in FIGS. 11-13B is one aspect of the operator presence system, which utilizes the operator platform 74. For clarity, the transmissions 86 coupled to each motor 84 and the drive gear shaft 90 coupled to each drive wheel 18 are hidden in these figures. Also for clarity, in FIG. 11, a plate 77 coupled to the foot well 72 has been removed to show portions beneath. As discussed above, the operator platform 74 may be pivotally mounted to a forward portion of the foot well 72. The operator platform 74 may include pins 126 that are received in slots 128 formed in the foot well 72. The pins 126 may be positioned rearwardly along a side edge of the operator platform 74. The slots 128 may provide a track through which movement of the pins 126 and therefore the operator platform 74 is restricted. A lateral opening 130 is formed in one of the sidewalls of the foot well 72. A contacting member 132 is fastened to a side of the operator platform 74 and extends through the lateral opening 130. A contacting sensor 134 is coupled to the sidewall of the foot well 72 proximate the lateral opening 130. The contacting member 132 is configured to contact the contacting sensor 134 when the operator platform 74 is in a fully raised position.

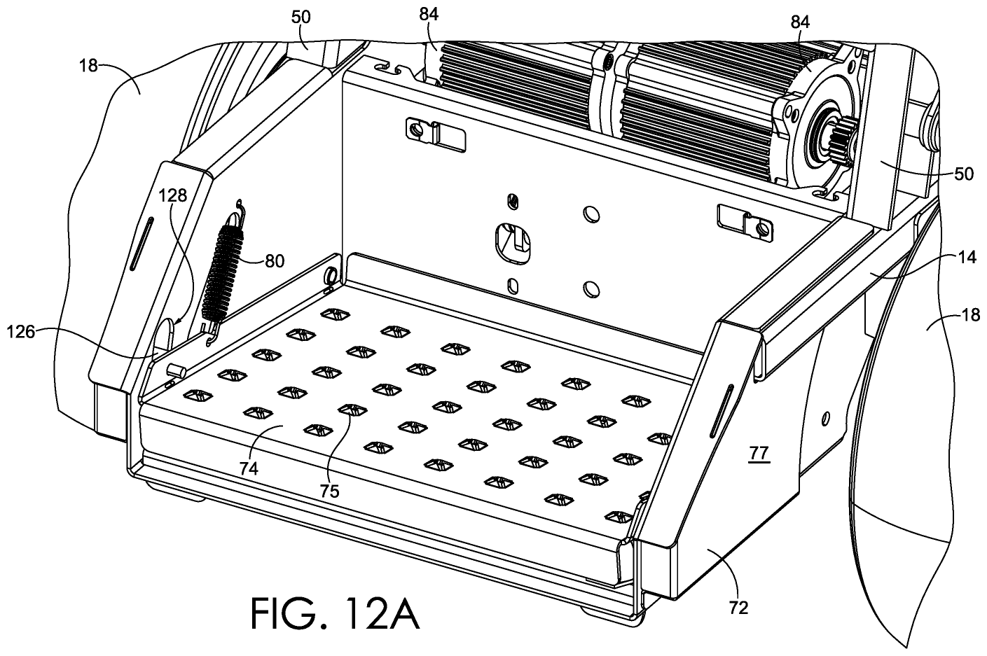

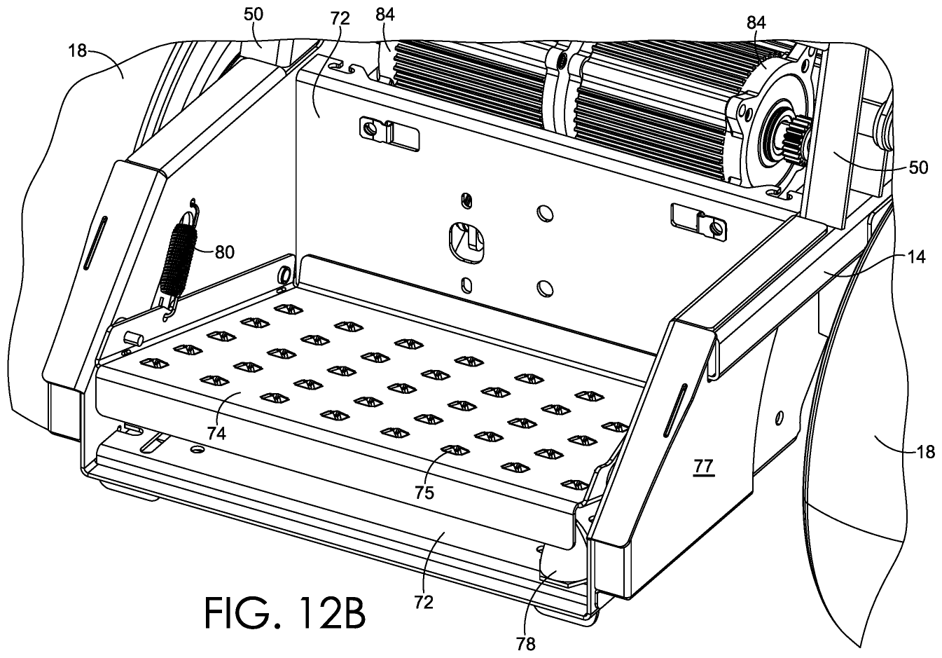

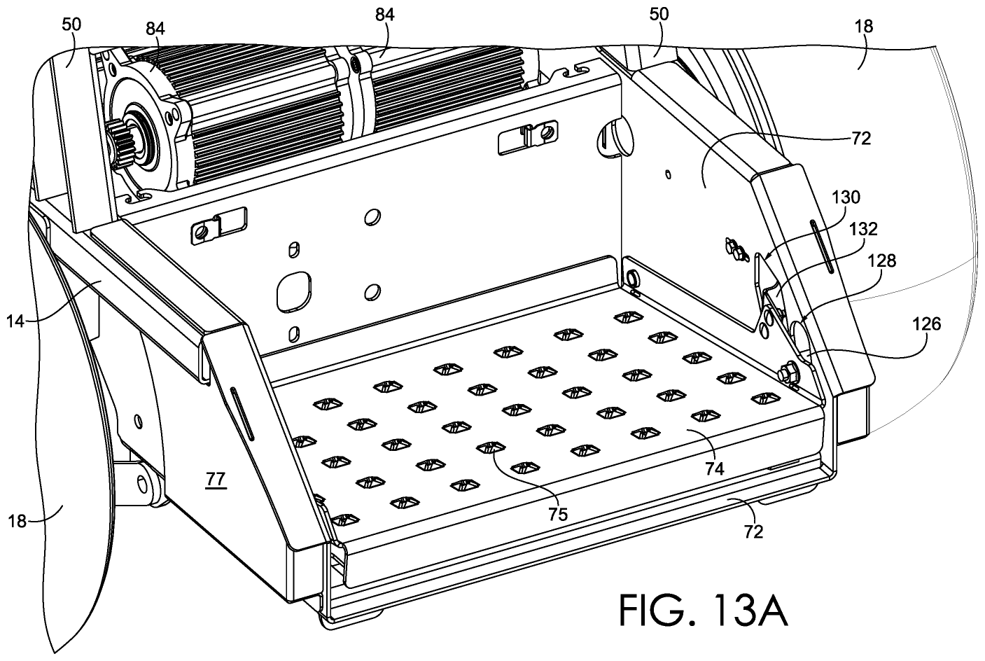

The fully lowered position of the operator platform 74, which is the position reached when an operator is present on the mower 10, is shown in FIGS. 12A and 13A. The fully raised position of the operator platform 74, which is the position that the dampers 76, 78 and 80 bias the operator platform 74 towards when an operator is not present on the mower 10, is shown in FIGS. 12B and 13B. In other words, the dampers 76, 78 and 80 hold the operator platform 74 in the fully raised position whereby the contacting member 132 contacts the contacting sensor 134. This contact results in the contacting sensor 134 sending a first signal to a controller that indicates an operator is not present on the mower 10. When an operator steps onto the mower 10, the operator platform is pressed down and towards the fully lowered position whereby the contacting member 132 loses contact with the contacting sensor. This loss of contact results in the contacting sensor 134 sending a second signal to the controller that indicates an operator is present on the mower 10. In aspects, the first signal results in the controller instructing setting of the parking brake 98 and the second signal results in the controller instructing release of the parking brake 98.

In other aspects, the contacting sensor 134 may comprise an electric switch that is open when the contacting member 132 makes contact and is closed when the contacting member 132 loses contact. In still other aspects, the contacting sensor 134 may not be a sensor at all and may be a stop for the operator platform 74. In these aspects, a different sensor may be present at another location on the mower 10. The different sensor may still detect the position of the operator platform 74 and provide an indication to the controller when the operator platform 74 is in the fully raised position and a different indication when the operator platform 74 is not in the fully raised position. Alternatively, the different sensor may provide an indication to the controller when the operator platform 74 is in the fully lowered position and a different indication when the operator platform 74 is not in the fully lowered position.

Sometimes it may be advantageous for the controller to test the indications received from the contacting sensor 134 to ensure an accurate reading. For example, if the mower 10 is being driven over rough terrain, an operator's weight applied to the operator platform 74 may be lessened (perhaps to zero) when encountering a bump in the terrain, at least momentarily. In this circumstance, if the dampers 76, 78, and 80 push/pull the platform 74 back into the fully raised position the contacting sensor 134 will provide a signal indicating the operator is not present on the mower 10 until the operator's weight is again applied to the platform 74. During this brief period of time, previous mowers would set the parking brake despite the operator still being aboard the mower albeit temporarily lifted. This automatic setting of the parking brake by previous mowers caused unnecessary wear on the components of the parking brake and in extreme situations could cause an operator to lose his or her balance with a sudden stop. The present invention solves these problems by testing an indication of lack of operator presence before the controller instructs engagement of the parking brake 98. For example, the controller may delay instructing engagement of the parking brake 98 for a predetermined period of time (e.g., one second, half of one second, two seconds, etc.). If the indication of lack of operator presence is received for longer than the predetermined period of time, then the controller instructs setting (i.e., engagement) of the parking brake 98. In other aspects, if the contacting sensor 134 provides a signal indicating lack of operator presence, then a secondary signal from another sensor configured to detect the presence of an operator could be checked by the controller before instructing setting (i.e., engagement) of the parking brake 98. For example, a secondary sensor associated with one or more of the steering levers 60 and 62 may provide the secondary signal to the controller. In this example, the controller would instruct setting (i.e., engagement) of the parking brake 98 only if both the signal from the contacting sensor 134 and the secondary signal from the secondary sensor agreed that an operator was not present on the mower 10.

Other times, it may be advantageous for the controller to test the indications received from the contacting sensor 134 prior to causing release of the parking brake 98. For example, when an operator initially mounts the mower 10 they may not be ready to operate the mower 10 immediately. Thus, before the operator is ready to operate the mower 10 it may be advantageous for the parking brake to remain engaged. In these situations, it would be advantageous to disengage the parking brake after it is determined that the operator is ready to operate the mower 10. The present invention solves these problems by testing an indication of operator presence before the controller instructs disengagement of the parking brake 98. For example, disengagement of the parking brake 98 may be conditioned upon the controller first receiving a second signal indicative of the operator being ready to operate the mower 10. In some aspects, the second signal may be related to movement of a steering lever 60 and/or 62.

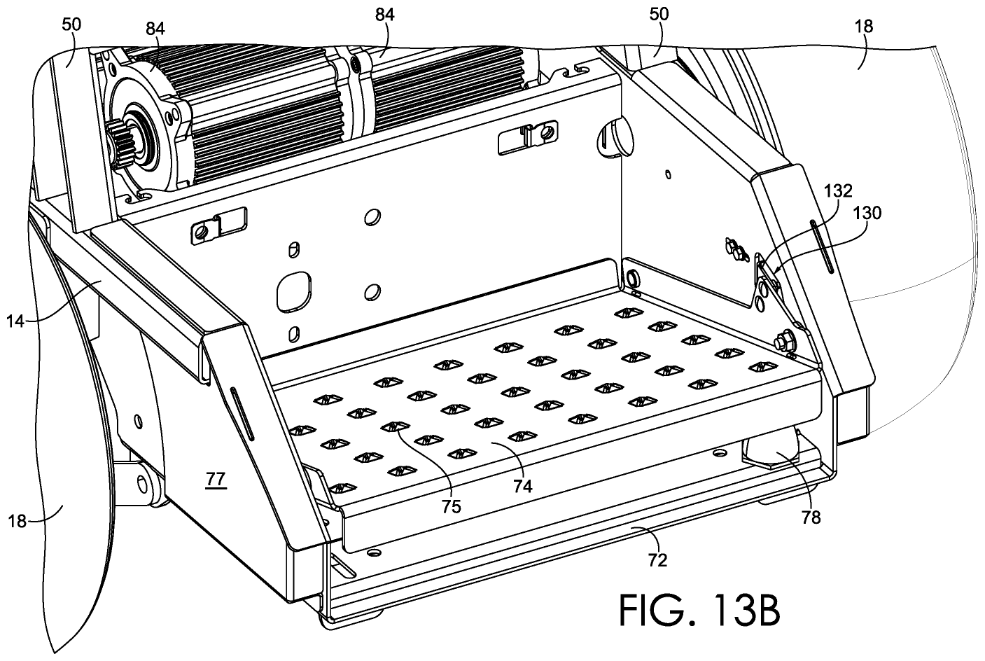

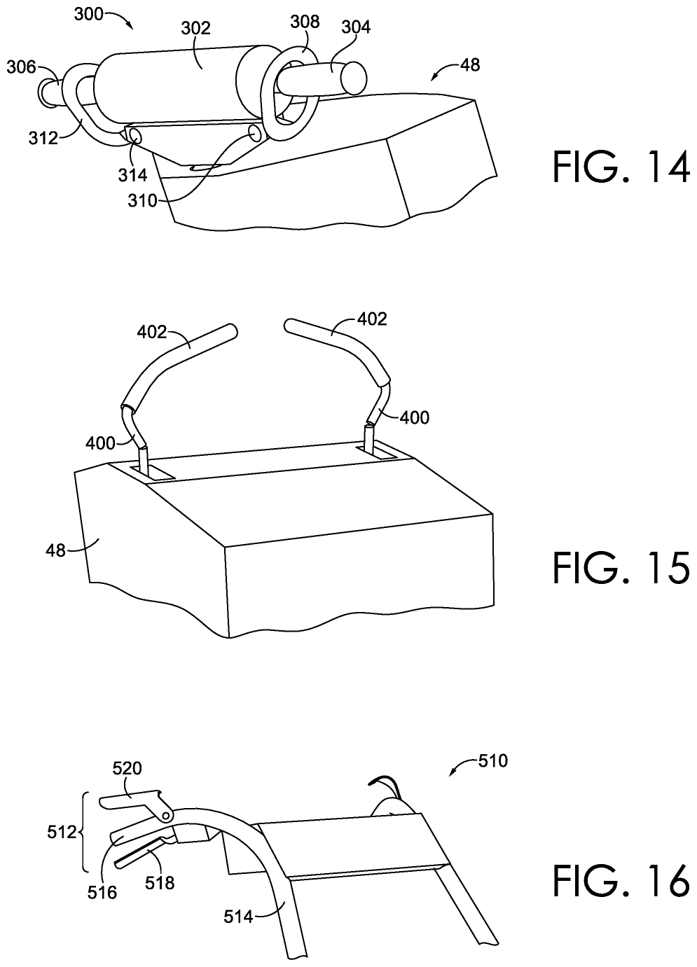

An alternative operator presence system is depicted in FIG. 14, where like features are labeled with like reference numbers. Propulsion and/or steering may be controlled via throttle-style inputs 300. The throttle-style inputs 300 may be coupled to the control tower 48 and include a central portion 302, a right throttle 304, and a left throttle 306. In addition, the throttle-style inputs 300 include a right ring 308 pivotally coupled to the central portion 302 at pivot point 310 and a left ring 312 pivotally coupled to the central portion 302 at pivot point 314. The right throttle 304 extends through the right ring 308 and the left throttle extends through the left ring 312. A right switch and a left switch extend from the central portion 302 and are in a first state (i.e., open or closed) when the rings 308 and 312 are in a lowered position (such as when an operator is not grasping the throttles 304 and 306). The right switch and the left switch are in a second state (i.e., open or closed and different from the first state) when the rings 308 and 312, respectively, are in a raised position (such as when an operator is grasping the throttles 304 and 306). In aspects, the switches may comprise sensors that send an indication to a controller. In other aspects, the switches may comprise a portion of an electric circuit and permit or prevent a current or a voltage from being detected by a controller. In still other aspects, the throttle-style inputs 300 could be applied to a walk-behind mower instead of a stand-on mower.

Another alternative operator presence system is depicted in FIG. 15, where like features are labeled with like reference numbers. In this aspect, steering levers 400 are coupled to the control tower 48 and have flip open handles 402. For example, the steering levers 400 each include a handle 402 hingedly coupled to a top of said steering lever 400. A biasing mechanism may hold the handles 402 in the open position depicted. When an operator grasps the steering lever 400, they can manipulate the handles 402 to a closed position. A switch may be coupled to the top end of the steering levers 400 or the bottom end of the handles 402 and may change state in response to the handles 402 moving between the open position and the closed position. In aspects, the switch may comprise a sensor that sends an indication to a controller. In other aspects, the switch may comprise a portion of an electric circuit and permit or prevent a current or a voltage from being detected by a controller.

Control of a parking brake 98 based on an operator presence system can be accomplished in other types of mowers, such as walk-behind mowers and riding mowers. As discussed above in reference to FIG. 14, the throttle-style inputs 300 could be applied to a walk-behind mower. Alternatively, a walk-behind mower 510 may include a pistol grip 512 coupled to an operator handle 514. The pistol grip 512 may include a frame portion 516, a propulsion lever 518, and an operator presence lever 520. The operator presence lever 520 may be grasped by an operator and move proximate the frame portion 516. This movement of the operator presence lever 520 may change the state of a switch associated with the walk-behind mower 510. In aspects, the switch may comprise a sensor that sends an indication to a controller. In other aspects, the switch may comprise a portion of an electric circuit and permit or prevent a current or a voltage from being detected by a controller.

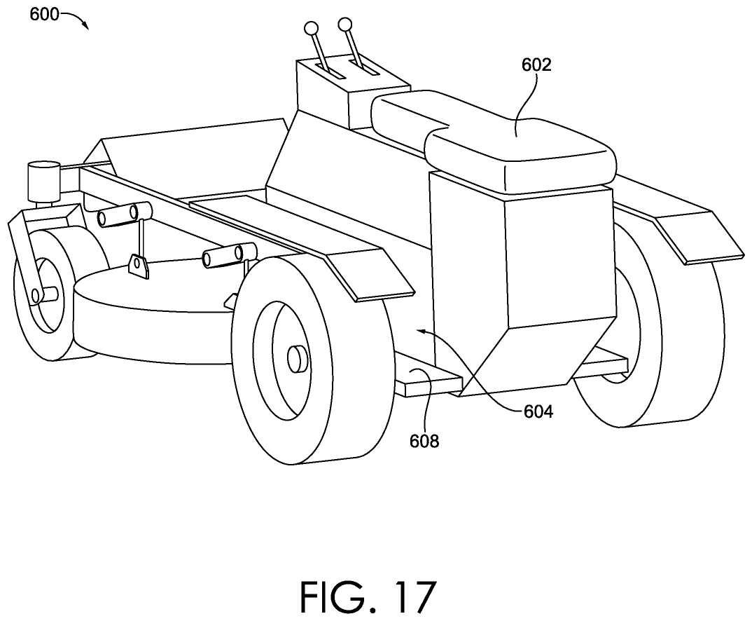

Riding mowers may detect operator presence in a variety of ways. For example, steering levers having flip-open type handles hingedly coupled thereto, similar to those discussed in reference to FIG. 15 except the steering levers would be coupled to the mower in a different location, may be used. In other aspects, a sensor may be positioned proximate an operator seat (e.g., under the operator seat) to detect when an operator is seated in the operator seat. In the aspect depicted in FIG. 17, a riding mower 600 includes an operator seat 602 and a foot well 604 on either side of the operator seat 602. In some aspects, a foot pedal 606 is positioned within foot well 604. The foot pedal 606 is depressed when an operator is present on the mower 600. A sensor detects the depressed foot pedal 606 and sends a signal to a controller to indicate presence of the operator. When the foot pedal 606 is not depressed, the sensor sends a second signal to the controller to indicate the operator is not present on the mower 600. In other aspects, a bottom plate 608 of the foot well is a pressure plate. In these aspects, the sensor detects depression of the bottom plate 608, or lack thereof, in the same way it detects depression of the foot pedal 606.

Additionally, although some exemplary implementations of the embodiments described herein are shown in the accompanying figures, these implementations are not intended to be limiting. Rather, it should be understood that the various embodiments and aspects described herein may be implemented upon any mower having a cutting deck suspended therefrom.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. An electric terrain working vehicle comprising:
a frame;
a controller coupled to the frame;
an operator presence system configured to detect a presence or absence of an operator in relation to the electric terrain working vehicle, the operator presence system also configured to provide a presence indication to the controller, wherein each presence indication comprises an indication of absence or an indication of presence; and
a parking brake configured to actuate between an engaged state and a disengaged state,
wherein the controller commands actuation of the parking brake to the engaged state after receiving the indication of absence,
wherein the controller commands actuation of the parking brake to the disengaged state after receiving the indication of presence.

2. The electric terrain working vehicle of claim 1, wherein after receiving a first presence indication comprising an indication of absence the controller does not command actuation of the parking brake to the engaged state until a second presence indication is received after a period of time has elapsed and the second presence indication matches the first presence indication.

3. The electric terrain working vehicle of claim 2, wherein the period of time is at least half of one second.

4. The electric terrain working vehicle of claim 1 further comprising:
the operator presence system comprising a first sensor configured to provide a first presence indication to the controller and a second sensor configured to provide a second presence indication to the controller,
wherein after receiving the first presence indication comprising an indication of absence from the first sensor the controller does not command actuation of the parking brake to the engaged state until the second presence indication is received from the second sensor and the second presence indication matches the first presence indication.

5. The electric terrain working vehicle of claim 4, wherein the electric terrain working vehicle comprises a stand-on mower having an operator platform coupled to the stand-on mower and movable between a first position associated with an operator being absent relative to the stand-on mower and a second position associated with the operator being present relative to the stand-on mower, wherein the first sensor is configured to detect the operator platform in the first position.

6. The electric terrain working vehicle of claim 5 further comprising a steering lever coupled to the stand-on mower and movable between an operable state associated with an operator being present relative to the stand-on mower and an inoperable state associated with the operator being absent relative to the stand-on mower, wherein the second sensor is configured to detect the steering lever in the inoperable state.

7. The electric terrain working vehicle of claim 4, wherein the electric terrain working vehicle comprises a stand-on mower having steering lever coupled to the stand-on mower and movable between an operable state associated with an operator being present relative to the stand-on mower and an inoperable state associated with the operator being absent relative to the stand-on mower, wherein the first sensor is configured to detect the steering lever in the inoperable state.

8. The electric terrain working vehicle of claim 4, wherein the electric terrain working vehicle comprises a walk-behind mower having throttle-style inputs, the throttle-style inputs include a central portion, a right throttle extending from a right side of the central portion, and a left throttle extending from a left side of the central portion, further comprising:
a right ring coupled to the right side of the central portion, the right throttle extending through the right ring;
a left ring coupled to the left side of the central portion, the left throttle extending through the left ring;
each of the right ring and the left ring configured to move between a first position associated with an operator being absent relative to the walk-behind mower and a second position associated with the operator being present relative to the walk-behind mower, wherein the first sensor is configured to detect the right ring in the first position and the second sensor is configured to detect the left ring in the first position.

9. The electric terrain working vehicle of claim 4, wherein the electric terrain working vehicle comprises a walk-behind mower having one or more pistol grips, each pistol grip including a frame portion, a propulsion lever extending from the frame portion, and an operator presence lever extending from the frame portion, further comprising:
each operator presence lever configured to move between a first position associated with an operator being absent relative to the walk-behind mower and a second position associated with the operator being present relative to the walk-behind mower, wherein the first sensor is configured to detect a first operator presence lever in the first position and the second sensor is configured to detect a second operator presence lever in the first position.

10. The electric terrain working vehicle of claim 4, wherein the electric terrain working vehicle comprises a riding mower having an operator seat coupled to the frame, the operator seat configured to move between a first position associated with an operator being absent relative to the riding mower and a second position associated with the operator being present relative to the riding mower, wherein the first sensor is configured to detect the operator seat in the first position.

11. The electric terrain working vehicle of claim 4, wherein the electric terrain working vehicle comprises a riding mower having an operator foot pedal pivotally coupled to the frame, the operator foot pedal configured to move between a first position associated with an operator being absent relative to the riding mower and a second position associated with the operator being present relative to the riding mower, wherein the first sensor is configured to detect the operator foot pedal in the first position.

12. The electric terrain working vehicle of claim 1 further comprising:
the operator presence system comprising a first sensor configured to provide a presence indication to the controller and a second sensor configured to provide an operation indication to the controller,
wherein after receiving the first presence indication comprising an indication of presence from the first sensor the controller does not command actuation of the parking brake to the disengaged state until after the operation indication is received from the second sensor.

13. The electric terrain working vehicle of claim 12, further comprising:
the electric terrain working vehicle comprises a stand-on mower having an operator platform coupled to the stand-on mower and movable between a first position associated with an operator being absent relative to the stand-on mower and a second position associated with the operator being present relative to the stand-on mower;
a steering lever coupled to the stand-on mower and movable between an operable state associated with an operator being present relative to the stand-on mower and an inoperable state associated with the operator being absent relative to the stand-on mower,
wherein the first sensor is configured to detect the operator platform in the first position, wherein the second sensor is configured to detect the steering lever in the inoperable state.

14. The electric terrain working vehicle of claim 1, wherein the parking brake is mechanically actuated between the engaged state and the disengaged state.

15. The electric terrain working vehicle of claim 1, wherein the parking brake is electrically actuated between the engaged state and the disengaged state.

16. The electric terrain working vehicle of claim 1, wherein the parking brake is electrically actuated to the engaged state and mechanically actuated to the disengaged state.

17. The electric terrain working vehicle of claim 1, wherein the parking brake is operatively coupled to a transmission.

18. An electric terrain working vehicle comprising:
a frame comprising a first frame rail opposite a second frame rail, each frame rail extending in a longitudinal direction;
a transmission coupled to the frame, the transmission comprising an intermediate gear shaft that rotates about a first lateral axis and a drive gear shaft that rotates about a second lateral axis; and
a motor having an output shaft that rotates about a third lateral axis and coupled to the intermediate gear shaft,
wherein the first, second and third lateral axis are parallel to one another, perpendicular to the longitudinal direction, and oriented such that the transmission and the motor present a vertical alignment relative to the frame.

19. The electric terrain working vehicle of claim 18, wherein a parking brake is operatively coupled to the intermediate gear shaft.

20. The electric terrain working vehicle of claim 18, wherein a drive wheel is operatively coupled to drive gear shaft.
